(19) United States
(12) Patent Application Publication
(10) Pub. No.: US 2012/0233203 A1
(43) Pub. Date: Sep. 13, 2012

(54) INFORMATION PRESENTATION DEVICE

(75) Inventors: Yu Kaneko, Kanagawa-ken (JP); Tomonori Maegawa, Tokyo (JP); Shigeo Matsuzawa, Tokyo (JP); Kotaro Ise, Saitama (JP)

(73) Assignee: KABUSHIKI KAISHA TOSHIBA, Tokyo (JP)

(21) Appl. No.: 13/422,857

(22) Filed: Mar. 16, 2012

Related U.S. Application Data
(63) Continuation of application No. PCT/JP2009/006325, filed on Nov. 24, 2009.

(51) Int. Cl. G06F 17/30; G06F 15/16

(52) U.S. Cl. 707/769; 707/E17.014; 707/E17.019

(57) ABSTRACT

Certain embodiments provide a Web server, which is provided with a request reception unit for receiving a picture request including a picture ID for identifying a picture from a browser, and an information collection unit for finding the point ID corresponding to the picture ID included in the picture display request, and collecting the value of the point identified by the point ID from an IP controller. The information collection unit calculates the predictive starting time at which the value of the point is collected before the next picture display request is made from the current time, the collection time and the previous picture display request. The information collection unit collects the value of a point from the IP controller at the predictive starting time.

### CROSS REFERENCE TO RELATED APPLICATIONS

This application is a continuation of International Application No. PCT/JP2009/006325 filed Nov. 24, 2009, the entire contents of which are incorporated herein by reference.

### FIELD

Embodiments described herein relate to an information presentation device (a Web server).

### BACKGROUND

In a building management system, there is a Web server which collects a facility information on such a facility equipment as an air conditioner, an illumination equipment and the like, from Internet protocol (IP) controllers which monitor a facility equipment to notify a facility information to the Web browser. Facility information is a temperature of the air conditioner, a luminance, for example. With this Web server, a building manager or tenant residents can monitor and control their building by using a Web browser, without installing special monitoring software.

A conventional Web server has collected facility information by means of IP controllers which can notify a facility information to a Web server when a facility information has changed.

However, there are some IP controllers which cannot frequently notify facility information and IP controllers which have no function to notify facility information. In this case, the Web server cannot fully acquire the facility information.

To fully acquire the information of the facility equipment, it is necessary for the Web server to receives a request for facility information from the Web browser and then to requests facility information to IP controllers. However, it takes a long time for the Web server to collects facility information from IP controllers in such a building management system, since it takes a long time for the IP controller to acquire the facility information. As a result, this causes an increase in time for displaying a picture on the browser, which results in increase in stress of the users of the Web browser.

### BRIEF DESCRIPTION OF THE DRAWING

FIG. 1 is a view showing a building management system;

FIG. 2 is a block diagram of a Web server;

FIG. 3 is a time chart of an operation of a Web server of an embodiment 1;

FIG. 4 is a view showing a picture information DB of the Web server of the embodiment 1;

FIG. 5 is a view showing a facility information DB of the Web server of the embodiment 1;

FIG. 6 is a view showing an update interval DB of the Web server of the embodiment 1;

FIG. 7 is a view showing an information collection time DB of the Web server of the embodiment 1;

FIG. 8 is a flowchart of an operation at a request reception time of the Web server of the embodiment 1;

FIG. 9 is a block diagram of an information collection unit;

FIG. 10 is a flowchart of pre-reading processing of the Web server of the embodiment 1;

FIG. 11 is a time chart of an operation of a Web server of an embodiment 2;

FIG. 12 is a picture information DB of the Web server of the embodiment 2;

FIG. 13 is a flowchart of an operation at a request reception time of the Web server of the embodiment 2;

FIG. 14 is a flowchart of pre-reading processing of the Web severs of the embodiment 2;

FIG. 15 is a time chart of an operation of a Web server of an embodiment 3

FIG. 16 is a flowchart of an operation at a request reception time of the Web server of the embodiment 3;

FIG. 17 is a flowchart of pre-reading processing of the Web server of the embodiment 3;

FIG. 18 is a time chart of an operation of a Web server of an embodiment 4;

FIG. 19 is a time chart of an operation of a Web server of an embodiment 5; and

FIG. 20 is a view showing an information collection time DB of the Web server of the embodiment 5.

### DETAILED DESCRIPTION

Hereinafter, embodiments will be described.

According to an embodiment, an information presentation device, is provided with a request reception unit to receive a picture request which includes an picture identification (ID) which specifies a request picture from an external program; a facility information database (DB) to store a point ID which specifies a point that is information of external equipment connected to a management device and a value of the point; a picture information DB to stores the point ID which is stored in the facility information DB and the picture ID which identifies the picture which displays the value of the point specified by the point ID correspondingly; a collection time DB to store a collection time which is required to collect the value of the point corresponded to the picture ID; an information collection unit to calculate a request interval, when receiving the picture request from the request reception unit, by subtracting a previous request reception time from the request reception time which is a time at which the picture request has received, to calculate the next request reception time by adding the request interval to the request reception time, to calculate a pre-reading starting time by subtracting the collection time from the next request reception time, and to instruct the start of the collection of the value of the point to the management device when the pre-reading starting time comes; and a picture generation unit to obtain the value of the point from the facility information DB, when receiving the picture request from the request reception unit, and to generate the picture from the values of the obtained point to transmit.

According to the information presentation device of the embodiment described, the speed to notify the information of the facility equipment to the users can be increased when receiving the picture request from the users.

Hereinafter, embodiments will be described with reference to the drawings.

### Embodiment 1

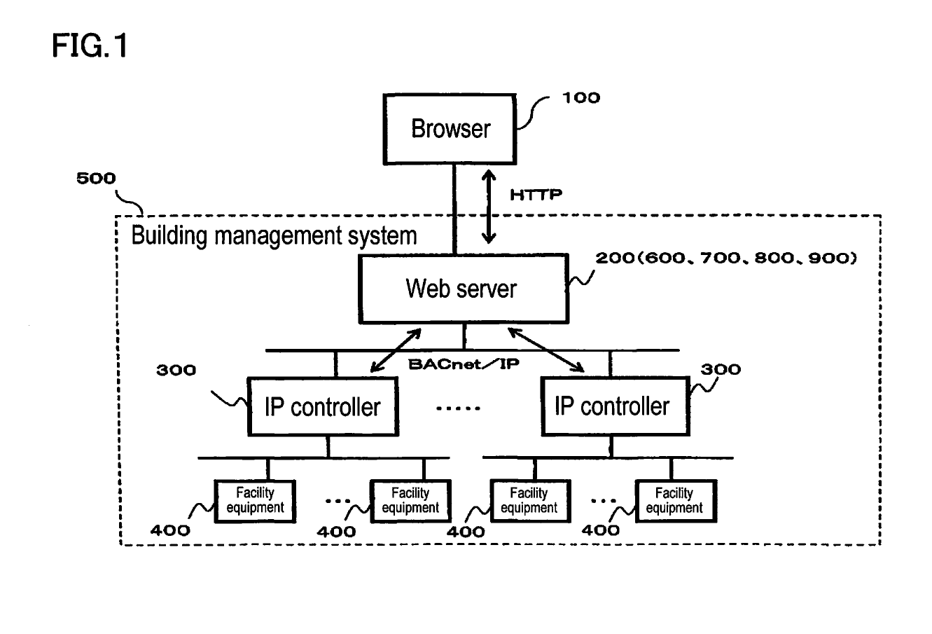

FIG. 1 is a view showing a building management system of an embodiment 1.

In a building management system 500, there is a Web server (an information presentation device) 200 which obtains a value of facility information (hereinafter, facility information of facility equipment 400 is referred to as a point) of facility equipment 400, such as an air conditioner and an illumination equipment and display values on a Web browser 100. The Web server 200, when receiving a picture request (e.g., a Hyper Text Transfer Protocol (HTTP) request), which requests a value of facility information of the facility equipment 400 to be managed by an Internet protocol (IP) controller 300. When obtaining the value of the point from the IP controller 300, the Web server 200 generates picture information constructed by using Hyper Text Markup Language (HTML) with plain text, image files and movie files, after that, sends it to the Web browser 100.

A ‘point’ represents facility information of facility equipment 400. For example, if the facility equipment 400 is an air conditioner, the set temperature of the air conditioner is a point. Information on ‘Power on/off’ of the air conditioner is also a point.

A picture information to be notified to the browser is, for example, temperatures of air conditioners in a list form or a transition of the temperatures of the air conditioner as a time-series graph. Picture information are generated based on values of the points. A communication protocol of a network on which the Web server 200 is connected to the IP controller 300 is, for example, a Building Automation and Control Networking (BACnet)/IP. The IP controller 300 is connected with the facility equipment 400 through a computer link, LonTalk or Ethernet (registered trade mark), for example.

An collection method of values of the points by the IP controller 300 includes acquisition from the facility equipment 400 when an acquisition request from the Web server 200 is received and acquisition by automatically notifying by the facility equipment 400 to the IP controller 300 when the values of the facility equipment 400 has changed.

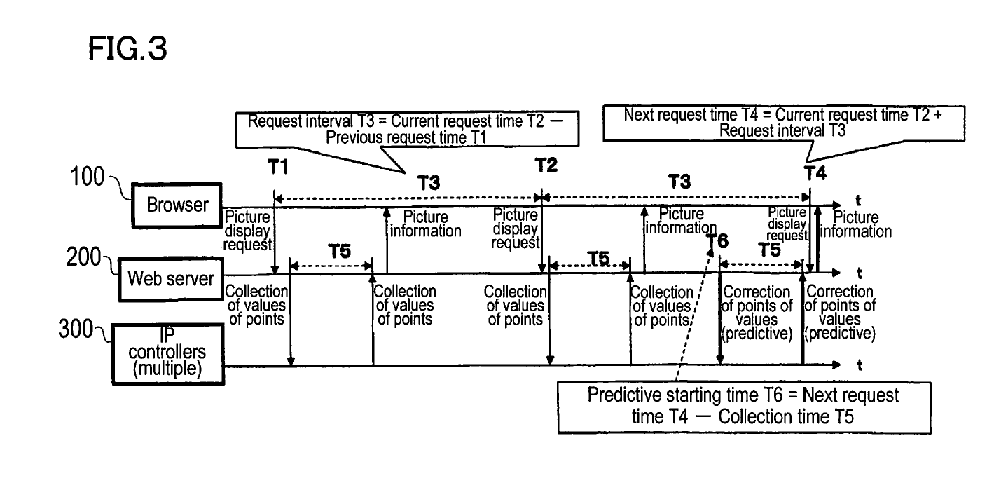

As shown in FIG. 3, the Web server 300 of this embodiment predicts a time (a next request time T4) at which the next picture request arrives from the Web browser 100, and obtains a time (a collection time T5) to collects the value of the points. Then, the Web server 200 collects the values of the points from the IP controller 300 at a pre-reading starting time T6 which has been calculated by subtracting the collection time T5 from the next request time T4, and by collecting the values of the points before the time at which the picture request is received from the Web browser 100. Thus, the Web server 200 generates the picture information from the values of the points to quickly notify it to the Web browser 100 when the picture request has come.

As a result, it is possible to quickly notify the values of the points to the users of the Web browser 100. For example, if the IP controller 300 takes a long time to collects the values of the points, and if it takes a long time to establish a communication between the Web server 200 and the IP controller, it is possible to increase the speed to notify the values of the points to the users of the Web browser 100.

Here, the foregoing next request time t4 can be calculate by adding a current request time T2 to a request interval T3 calculated by finding the difference between a time (a current request time T2) at which a picture request has currently arrived and a time (a previous request time T1) at which a picture request has previously arrived. Such The prediction method of the next request time T4 utilizes the fact that there are many cases in which the request intervals T3 of the picture requests are constant especially in the building management system.

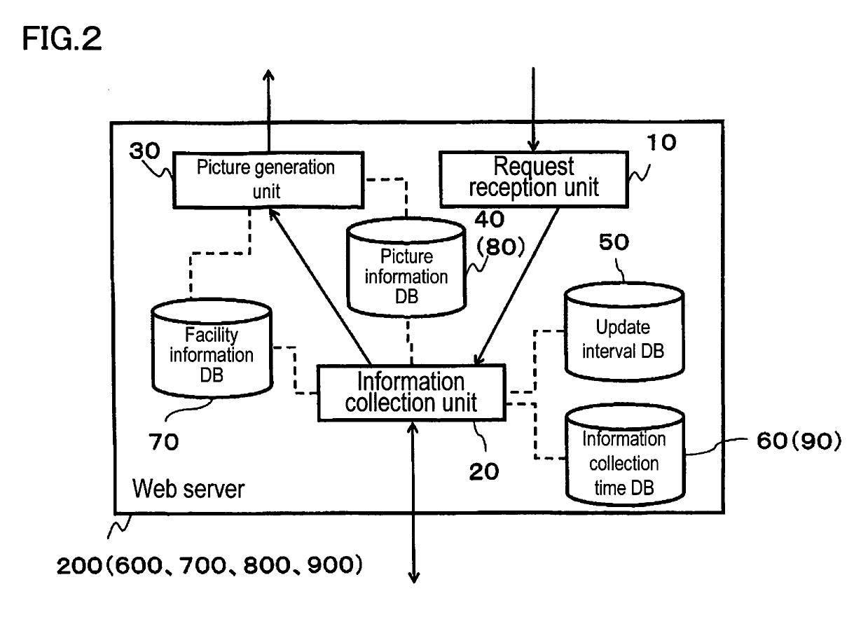

As shown in FIG. 2, the web server 200 according to the embodiment 1 comprises a request reception unit 10 configured to receive a picture request from the Web browser 100, an information collection unit 20 configured to collect values of points from the IP controller 300, a picture generation unit 30 configured to generate picture information from the values of the collected points and sends it to the Web browser 100, a picture information DB 40 configured to manage picture IDs and point IDs, an update interval DB 50, an information collection time DB 60, and a facility information DB 70. The Web browser 100 is not only the software which sends the picture request to the Web server 200.

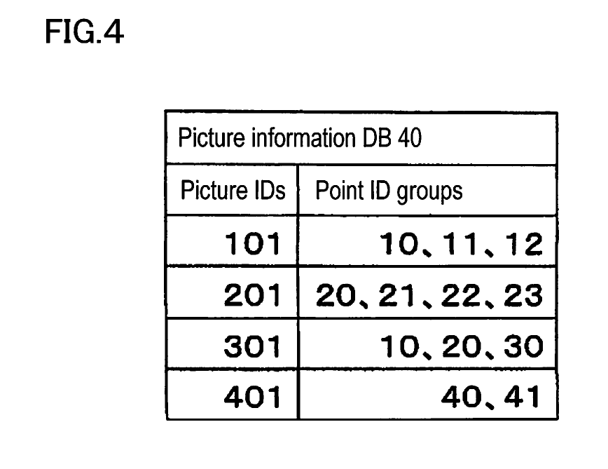

As shown in FIG. 4, the picture information DB 40 manages picture IDs and point IDs included in the picture. In other words, the picture information DB 40 defines point groups included in each picture. Here, the picture IDs are identifiers which specify the pictures to be displayed by the Web browser 100. The Web browser 100 includes the picture IDs in the picture request.

The point ID is an identifier which specifies each point. In FIG. 4, for example, the picture to be specified by a picture ID 101 includes the information to be specified by point IDs 10, 11, 12.

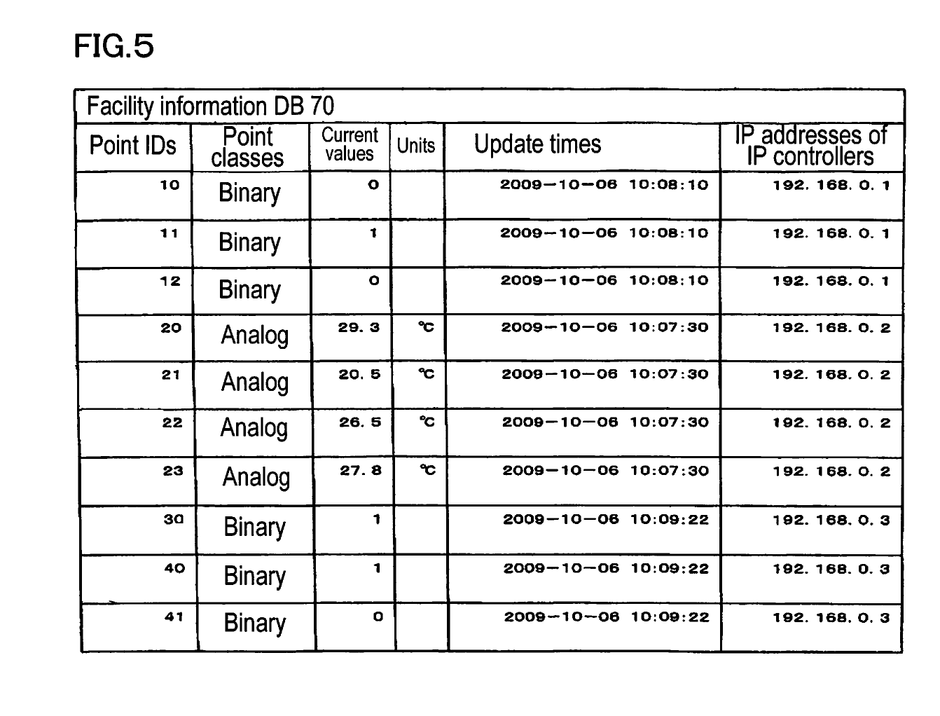

The facility information DB 70, as shown in FIG. 5, manages point classes, current values of the points, units of the current values, update times of the current values of the relevant point IDs and IP addresses of the IP controller for each point ID. Here, point class “binary” indicates that the points are information which indicates binary-value of on/off of the points (for example, 1 indicates on, 0 indicates off), and “analog” indicates that the points are analog-value information (for example, temperature of an air conditioner).

The “current value” is the value of the point. The unit is the unit of the current value. For example, for the point ID 20, its point class is analog-value information, the current values is 29.3, and its unit is ° C. (Celsius).

For the point ID 10, its point class is binary, and the current value is 0. That is, the point is information which indicates the off state.

The IP address of the IP controller is the IP address of the IP controller 300 which manages the points. By managing the IP addresses of the IP controller, the Web server 200 can collects the vales of points from the IP controller 300 by using a communication protocol, such as the BACnet/IP, for example.

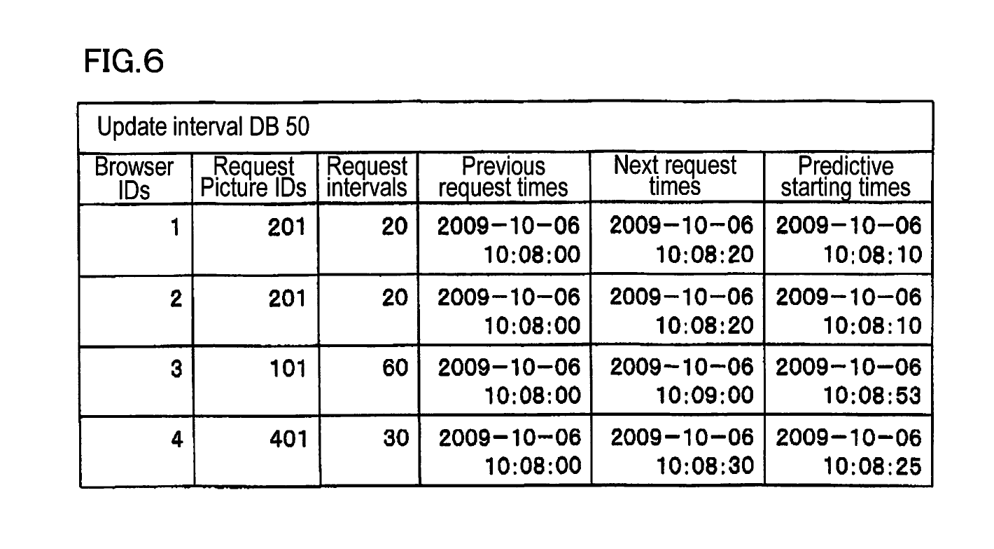

The update interval DB, as shown in FIG. 6, manages the browser IDs, the request picture IDs, the request intervals, the previous request times, the next request times and the pre-reading starting times. The browser ID is an identifier which specifies the Web browser 100, which is a unique value to each Web browser 100. The browser ID is assigned by the Web server 200 to each Web browser 100. As to the browser ID, HTTP cookie information, for example, is available which is generally used in web applications.

The request picture ID is a picture ID included in the picture requests from the Web browsers 100. As shown in FIG. 3, the request interval (T3) is a transmission interval of the picture requests to be specified by the request picture IDs transmitted from the Web browser 100 specified by the browser IDs. The request interval (T3) can be calculated by the difference between the current request time (T2) and the previous request time (T1). In this embodiment, the unit of the request interval (T3) is a second.

The next request time (T4) is a predicted time at which the Web browser 100 specified by the browser ID sends the next picture request to be specified by the request picture ID. The next request time (T4), for example, can be calculated by adding the request interval (T3) to the current request time (T2).

The pre-reading starting time (T6) is a time which starts collecting the values of points for generating the picture information to be specified by the request picture IDs from the IP controller prior to the next request time (T4). The pre-reading starting time (T6) can be calculated by subtracting the collection time (T5) to be hereinafter described from the next request time (T4).

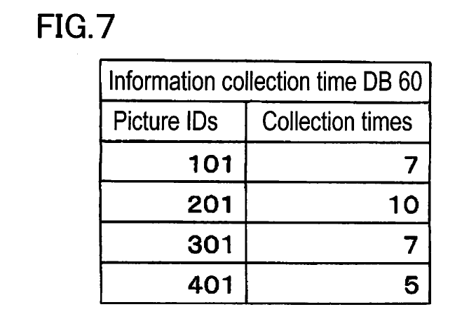

The information collection time DB 60, as shown in FIG. 7, manages the picture IDs and the collection times. The collection times (T5) are the time required to collect the values of the points included in the picture to be specified by the picture IDs from the IP controller 300. In this embodiment, the unit of the collection times (T5) is second.

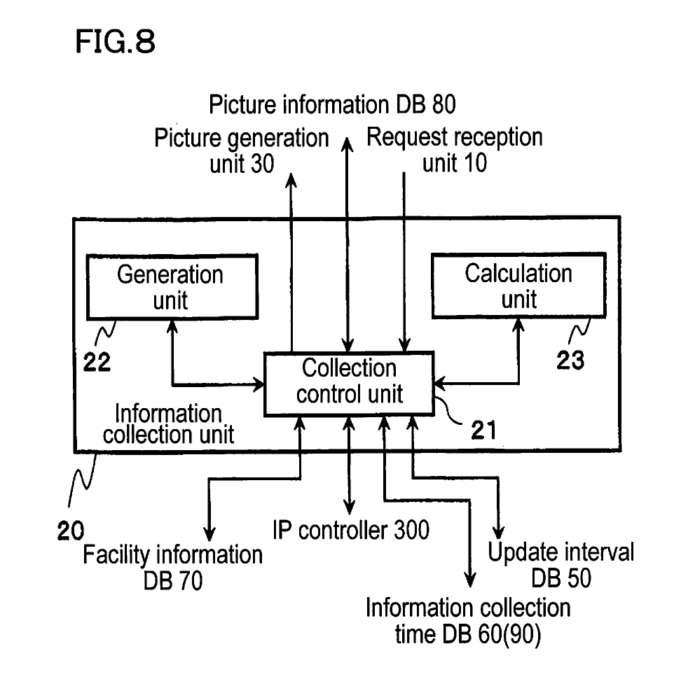

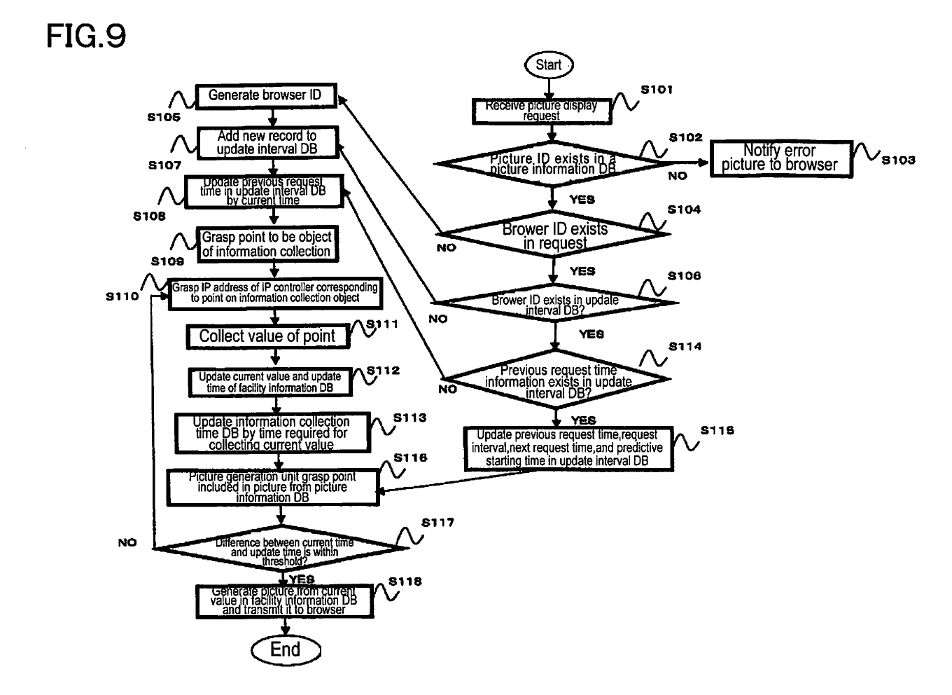

Next, operations will be explained when the picture requests are received from the Web browser 100 of the Web server 200 according to the example 1. As shown in FIG. 8, the information collection unit 20 is provided with a collection control unit 21, a generation unit 22, and a calculation unit 23. FIG. 9 is a flowchart illustrating operations of the Web server 200 according to the embodiment 1.

At first, the request reception unit 10 receives the picture requests from the Web browser 100 (S101). The request reception unit 10 transfers the picture request to the information collection unit 20. Here, the picture request includes the picture IDs, which indicates the picture information to be finally displayed on the Web browser 100. There is a case in which the picture request includes or does not include the browser ID of the Web browser.

Next, a collection control unit 21 of the information collection unit 20 confirms whether or not a picture information record (picture IDs and point ID groups) which has the same picture IDs as those of the picture IDs included in the picture request (S102) exists in the picture information DB 40.

If the picture information record which has the same picture IDs does not exist in the picture information DB 40, the collection control unit 21 directs the picture generation unit 30 to generates an error picture information. According to the indication from the information collection unit 20, the picture generation unit 30 generates the error picture information to sends it to the Web browser 100 (S103). Meantime, if the picture information record exists in the picture information DB 40, the collection control unit 21 confirms whether or not a browser ID (e.g., cookie information) is included in the picture request (S104).

If the browser ID is not included in the picture request, the generation unit 22 of the information collection unit 20 generates the browser ID which specifies the Web browser 100 (S105). If the browser ID, on the other hand, is included in the picture request, the collection control unit 21 confirms whether or not the update interval record which has a browser ID that coincides with the browser ID (S106) exists in the update interval DB 50. In 5106, in the case in which the update interval record with which the browser ID coincides does not exist and after the generation unit 22 generates the browser ID (S105), the collection control unit 21 adds a new record to the update interval DB 50 (S107). Here, as the new record, the browser ID and the picture ID in which the request picture ID is included in the picture request is recorded. Meantime, the information of the request interval, the previous request time and the next request time in the new record is left empty.

The collection control unit 21 updates the previous display time of the record in the update interval DB 50 by the current time (S108), and refers to the picture information DB 40 to acquire the point ID groups corresponding to the picture IDs included in the picture request. That is, the point IDs of the points to be collected are obtained (S109).

The collection control unit 21 obtains the IP address of the IP controller 300 which manages the points to be collected (S110), and collects the values of the points to be collected on the basis of the IP address of the IP controller 300 (S111). The collection control unit 21 updates the values of the points collected, that is, updates the current values for each point ID (S112).

The collection control unit 21 reflects the required time to collect the information to collection time DB 60 (S113). In other words, the collection control unit 21 stores the picture IDs to be objects of the information collection and the required time for the collection (collection times) correspondingly in the DB 60, and orders the picture generation unit 30 to start the picture generation.

If the update interval record having the browser ID which coincides with the browser ID included in the picture request exists in the step S106, it is confirmed whether or not the previous request time is set to the update interval record (S114). If the previous request time information has not been set, the processes from S108 to S113 are executed. Then, the collection control unit 21 directs the picture generation unit 30 to start the generation of the picture.

If the previous request time information has been set in the update interval record, in the step S114, the request interval, the next request time, the previous request time and pre-reading starting time of the update interval DB 50 are updated (S115).

At first, the calculation unit 23 of the information collection unit 20 calculates the request interval by the following equation (1). Hereinafter, explanation will be given by referring to FIG. 3.

Request interval (T3)=Current time (T2)−Previous request time (T1) (1)

After calculating the request interval (T3), the collection control unit 21 updates the previous request time of the update interval DB 50 to the current time. After updating the previous time, the calculation unit 23 calculates the next request time (T4) by the following equation (2).

Next request time (T4)=Current time (T2)+Request interval (T3) (2)

After updating this next request time, the calculation unit 23 calculates the pre-reading starting time by the following equation (3)

Pre-reading starting time (T6)=Next request time (T4)−Collection time (T5) (3)

Here, the calculation method of the pre-reading starting time (T6) shown as the equation (3) means to start the pre-reading so that the information collection of the values of the points is just completes at the time at which the next picture request will arrive. In the equation (3), the collection time uses the collection time in the information collection time DB.

As is understood by the picture information DB shown in FIG. 4, the numbers and classes of the point IDs and IP controllers 300 which manage the points are different in the different picture IDs, the collection times of the values of the points are different for each picture. However, by managing the collection times for each picture using the information collection time DB 60, the pre-reading times can be appropriately decided.

Here, the pre-reading starting time (T6) may not be precisely equal to a value which is calculated by subtracting the collection time (T5) from the next request time (T4) according to the equation (3). If the value is larger than the value calculated, the collection of the values of the points will be completed before the time at which the next picture request comes. If the value is smaller than the value calculated, there is a case in which the collection of the values of the points will be completed after the time at which the next picture request comes. In either case, the time between the time at which the picture request arrives and the time at which the picture is generated to be sent to the browser can be significantly reduced.

After the S115, the collection control unit 21 directs the picture generation unit 30 to generate the picture information.

After the S113 or the S115, when receiving the instruction of the picture information generation from the collection control unit 21 of the information collection unit 20, the picture generation unit 30 refers to the picture information DB 40 and obtains the point ID groups corresponding to the picture IDs included in the picture request (S116). Then, the picture generation unit 30 refers to the facility information DB 70 to obtain each update time of the points ID included in the picture ID.

Thereafter, the picture generation unit 30 calculates the difference between the update time and the current time for each point, and determines whether or not the difference is larger than the predetermined threshold (S117). If the difference is larger than the threshold, which means that the information is too old, the picture generation unit directs the information collection unit 20 to re-collect the values of the points. When receiving the instruction, the collection control unit 21 of the information collection unit 20 performs the operations from the step S110 to the S113.

On the other hand, if the difference between the update time and the current time is within the threshold, the picture generation unit 30 refers to the values of the points of the facility information DB 70 to generate the picture, and transmits the picture to the Web browser 100 (S118).

The operation of the Web server 200 has been explained at the time when the picture request is received. As is understood by FIG. 3 and the equation (1) to the equation (3) for calculating the pre-reading starting time, it is necessary to obtain the request interval (T3) from the Web browser 100, and thus it is necessary to process the picture request at least two times.

Sequential type processing which obtains the values of the points after receiving the picture request are performed until the request interval (T3) is obtained (S109 to S113). After obtaining the request interval, it is possible to acquire the points in asynchronously with the picture request from the Web browser 100, and thus only the update of the update interval DB is performed, and the picture generation can be started without collecting the values of the points (S115 to S118) when receiving the picture request from the Web browser 100. Accordingly, the Web server 200 can shorten the response time to the picture request from the Web browser 100.

In this embodiment 1, though the request interval is calculated by simple calculation as shown by the equation (1), there exists an reasonable reason in the calculation. In other words, in this embodiment, the possibility of being desired to periodically update the picture to be displayed on the Web browser 100 is high, since the users of the Web browser 100 acquire the pictures in order to perform monitoring control of the facility equipment of the building management system.

For example, in the monitoring control system, some of the browsers 100 are provided with an automatic update functions of the picture, and able to set the update interval. Accordingly, it can be expected for the picture requests from the browsers 100 to be required to the Web server 200 at a constant cycle, and the request intervals can be required by the simple calculation equation as shown by the equation (1). As the result, it is possible to calculate the pre-reading starting times through a simple calculation by suing the equation (1) to equation (3), and it is possible to preliminarily collect the values of the points at appropriate times. Therefore, the Web server 200 of this embodiment 1 is especially effective in the monitoring control system, such as a building management system in which the picture requests are made at the constant cycle.

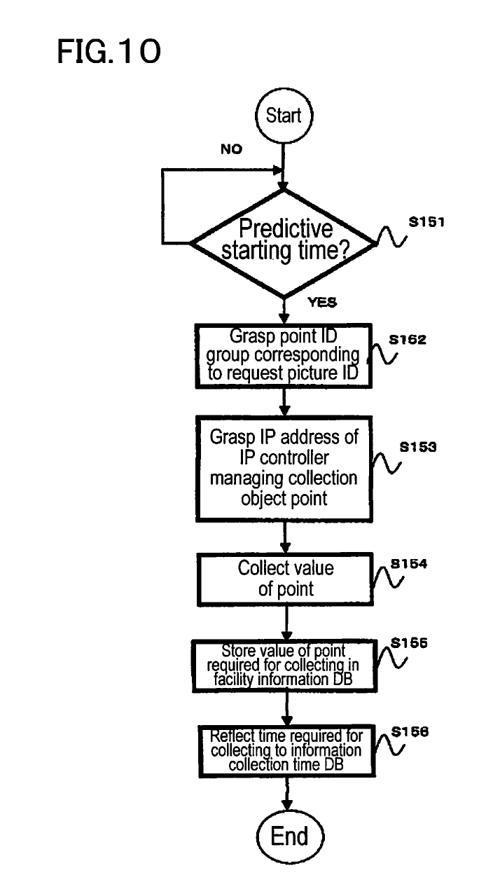

Next, by referring to FIG. 2 and FIG. 10, the pre-reading processing of the Web server 200 of the embodiment 1 will be described. Here, the pre-reading processing means the processing to acquire the information of the points prior to the picture request from the Web browser 100. FIG. 10 is a flowchart depicting the operations of the Web server 200 of the embodiment 1.

The collection control unit 21 of the information collection unit 20 refers to the picture information DB 40, when a time specified by the pre-reading starting information of each record of the update interval DB comes (S151), and obtains the point ID group of the same picture ID on the request picture which has already come to the time (S152). The collection control unit 21 refers to the facility information DB 70 to obtain an IP address of the IP controller 300 corresponding to the point ID to be an object (S153), and collects the values (current values) of the points (S154). The collection control unit 21, after collecting the values of the points, updates the current values corresponding to each point of the facility information DB, and updates the update times at the same time (S155). The collection control unit 21 reflects the required time to collect (the collection time) the values of all the points corresponding to the picture ID (S156).

As described above, the values of the points collected from S151 to S156 are updated in the facility information DB at a time when the picture requests come. As a result, as mentioned above, the Web server 200 can start the picture generation without having to collect the values of the points upon receiving the picture request from the Web browser 100 (S115 to S118). Accordingly, the Web server 200 can shorten the response time to the picture request from the Web browser 100.

As explained above, according to the Web server 200 of the embodiment 1, it is possible to increase the picture display speed on the Web browser 100, since it is possible to immediately start the picture generation when receiving the picture request by predicting the request time of the picture request from the Web browser 100 and executing the pre-reading so as to complete the collection of the values of the points until the next requesting time. As a result, the stress of the user due to the waiting for the display of the picture can be reduced.

### Embodiment 2

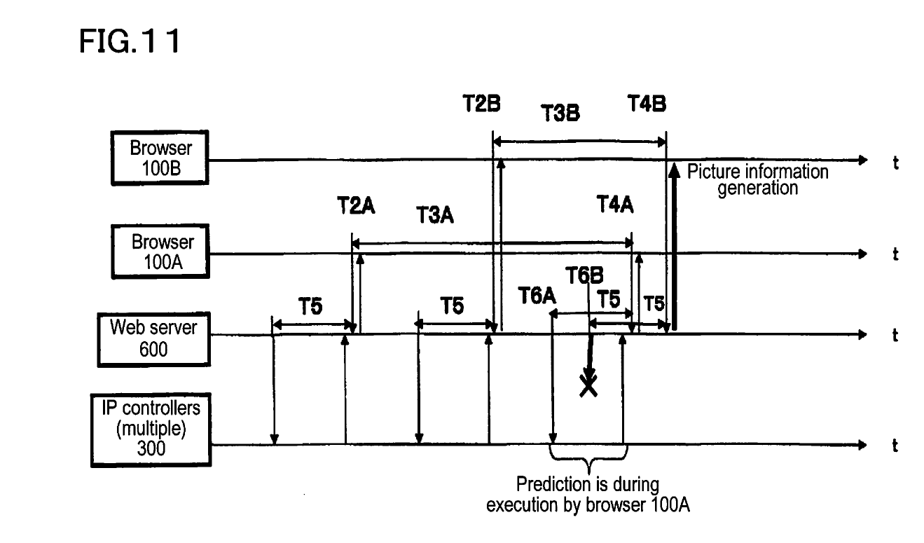

Next, Web server 600 according to the embodiment will be explained. FIG. 1 illustrates a configuration of a building management system including the server 600 of the embodiment 2. FIG. 2 illustrates a configuration of the Web server 600. FIG. 11 illustrates a time chart showing operation of the Web server 600.

Hereinafter, the operation of the Web server 600 will be explained by referring to FIG. 11.

When occurring a picture request of a certain picture from a certain Web browser 100A (or when a pre-reading starting time T6A comes), the Web server 600 according to the embodiment 2 brings a reading processing state of the requested picture into ‘executing’. If the picture request to the same picture occurs from another Web browser 100B (or if a pre-reading starting time T6B comes) while the reading processing state of the requested picture is ‘executing’, the Web server 600 does not perform the reading processing for the picture request from the another Web browser 100B (or prediction at the pre-reading starting time T6B), and generates the picture information by using the information that has been already acquired by the reading processing. The web server 600 can prevent the concurrent reading of the same picture (or prediction processing to the pre-reading stating time) by the picture request of the same picture and can achieve load reduction of the reading processing by the IP controller 300.

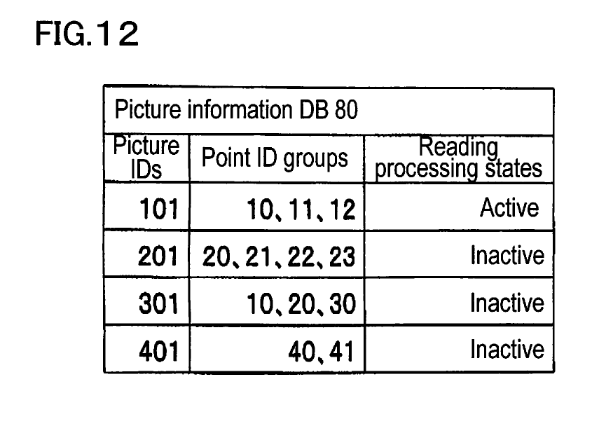

As shown in FIG. 2, the Web server 600 of the embodiment 2 is different in the construction of a picture information DB from that of the Web server of the embodiment 1, and the other constructions remain the same. In FIG. 12, picture information DB of the Web server 600 of the embodiment 2 is depicted. The picture information DB 80 manages the point ID groups and reading processing states for each picture ID, and differs from the picture information DB 40 of the embodiment 1 in managing the reading processing state. Here, the reading processing state is information showing whether or not the collection control units 21 of the information collection unit 20 are executing collection of the values of the points of the point ID groups corresponding to the picture IDs from the IP controller. The state of executing collection of the values of the points is represented as “executing”, and the state of not executing collection is represented as “not executing”.

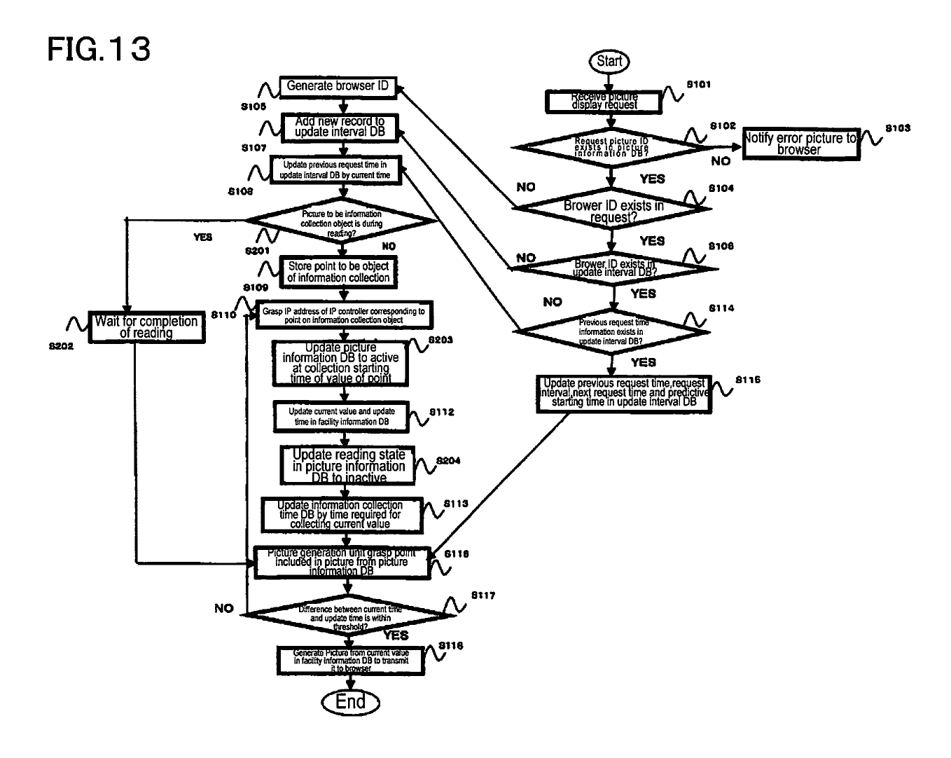

Next, operations of the Web server 600 when receiving the picture request with reference to FIG. 2 and FIG. 13. FIG. 13 is a flowchart depicting the operations of the Web server 200 according to the embodiment 2. In the flowchart, the same numbers are attached to the steps which operate the same operations as those of the Web server of the embodiment 1. Hereinafter, the steps which conduct different operations will be mainly explained. The Web server of the embodiment 2 is different from the Web server of the embodiment 1 in a process for collecting the values of the points.

As explained in the embodiment 1, the information collection unit 20 cannot execute prediction, since the request interval is not known at a first picture display request time and at a second picture display request time from the Web browser 100. Accordingly, as described in the explanation for the embodiment 1, it is necessary to collect the points by the sequential processing when receiving the request.

In that case, the collection control unit 21 updates the previous request time in the update interval DB 50 at a current time in S108. The collection control unit 21 confirms whether the reading processing state of the picture for the picture ID included in the picture request is “executing” (S201) by referring to the picture information DB 80. If the state is “executing”, the collection control unit 21 waits for completion of the reading, since the collection of the values of the points of the picture corresponding to the picture ID is being executed for the picture requests from the other browsers 100 (S202).

Here, the collection control unit 21 can detect the completion of the reading from the fact that the reading processing state of the picture information DB is made “not executing”. When detecting the completion of the reading, the collection control unit 21 directs the picture generation unit 30 to generate of the picture information. Then, the picture generation unit 30 generates the picture information to notify it to the Web browser 100. Here, the picture generation unit 30 creates the picture information on the basis of the current values of the facility information DB, when generating the picture information. These current values, however, are information collected by the request from other browsers 100 as mentioned above.

On the other hand, in S201, the collection control unit 21 obtains the point ID groups included in the pictures required by referring to the picture information DB 80 (S109) when the reading processing state for the picture ID requested by the picture display request is “not executing”. The collection control unit 21 obtains the IP addresses of the IP controllers 300 which manage each point of the point groups (S110) by referring to the facility information DB 70. The collection control unit 21 updates the reading processing states for reading of the picture IDs request in the picture information DB 80 to “executing” as well as starts the collection of the values of the points (S203). When collecting the values of the points, the collection control unit 21 reflects the current values of the corresponding points to the facility information DB, and updates the update times in the facility information DB by the times which reflect the current values to the facility information DB (112). The collection control unit 21 updates the reading processing state of the picture information DB to “not executing” (s204). The collection control unit 21 reflects the required time to collect the values of the points, as the collection times, to the information collection time DB 60 (S115). Then, the collection control unit 21 directs the picture generation unit to start the picture generation. The picture generation unit 30 generates the picture information to transmit it to the Web browser 100 (S116 to S118).

The above is explanation when the Web server 200 receives the picture request.

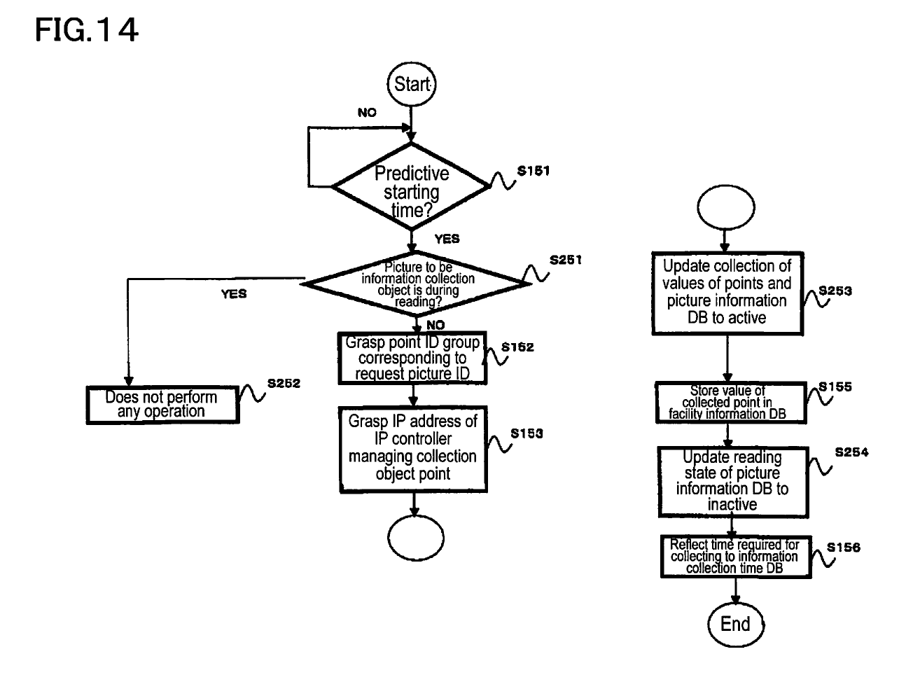

Next, the pre-reading processing of the Web server 600 will be set forth with reference to FIG. 2 and FIG. 14. FIG. 14 is a flowchart depicting the operations of the pre-reading processing of the Web server 600. In the flowchart, the steps which are common to the flowchart of FIG. 9 are attached the common numbers. Hereinafter, different steps will be mainly set forth.

At the time specified by the pre-reading starting time of each record of the update interval DB 50, the collection control unit 21 of the information collection unit 20 confirms whether or not the reading processing state of the picture ID of the picture to be read is “executing” (S251). If the state is “executing”, the collection control unit 21 does not perform any operation (S252).

On the other hand, if the reading processing state is “not executing”, the collection control unit 21 refers to the picture information DB 80 to obtain the point ID groups included in the picture IDs to be read (S152). The collection control unit 21 refers to the facility information DB 70 to obtain the IP address of the IP controller 300 which manages the point concerned (S153). The collection control unit 21 updates the reading processing state of the picture ID of the picture to be read regarding the picture information DB 80 to “executing” as well as starts the collection of the values of the points (S253). After collecting the values of the points, the collection control unit 21 also updates the update time as well as reflects the values (current values) of the collected points to the facility information DB (S155). The collection control unit updates the reading processing state for the picture ID of the requested picture of the picture information DB 80 to “not executing” (S254). The collection control unit 21 reflects the time required for collecting the values of the points, as collection time, to the information collection time DB 60 (S154).

As mentioned above, according to the Web server 600, it is possible to prevent from simultaneously performing the reading processing of the same picture ID in a short time, and to reduce the lord of the IP controller 300 by managing whether the reading processing is executed for each picture ID.

According to the Web server of the embodiment, as similar to the embodiment 1, it is possible to increase the speed of the transmission of the picture information in response to the picture display request from the Web server since the pre-reading processing can be executed.

### Embodiment 3

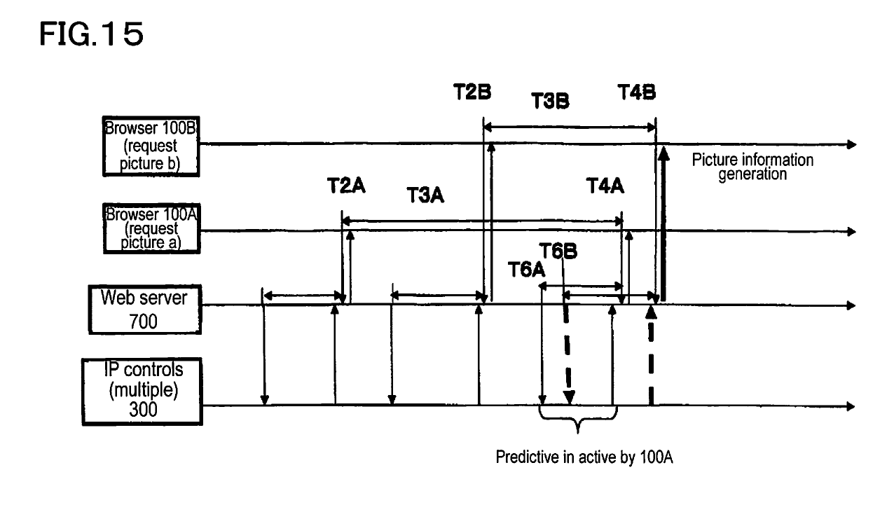

Next, a web server 700 according to an embodiment 3 will be set forth. FIG. 1 illustrates a configuration of a building management system including the Web server 700 of the embodiment 3. FIG. 2 illustrates the configuration of the Web server 700. Here, the picture information DB of the Web server 700 is picture information DB 80. FIG. 5 illustrates a time chart illustrating operations of the Web server 700. At first, by referring to FIG. 15, the operations of the Web server 700 will be set forth.

When a picture request for a certain picture ‘a’ occurred from a certain Web browser 100A (or when a pre-reading starting time T6A comes), the Web server 700 of the embodiment 3 makes a reading processing state for reading of the requested picture “executing”. When the picture reading processing state is “executing” and if a picture request, which is a picture display request for another picture b (or pre-reading at the pre-reading starting time T6B) from another Web browser 100B, but it includes the same point, is received (or if the pre-reading starting time T6B has come), the reading processing of the overlapped point (a point which is necessary to generate the picture b and a point necessary to generate the picture ‘a’) is not performed, and only performs the reading of the not overlapped point (a point which is necessary to generate the picture b, and a point which is not necessary to generate the picture a) (in FIG. 15, it is illustrated by a doted arrowed line to partially perform the reading) is performed. That is, according to the Web server 700, when the picture requests for different pictures from a plurality of browsers 100 occur in a short time (or, when the pre-reading starting time has come), it is possible to reduce the lord of the IP controller 300 by not performing the overlapped reading of the point requested.

Although the Web server of the embodiment 2 determines the overlapping of reading based on the picture, the Web server according to the embodiment determines overlapping of reading based on the point. Generally, in the monitoring systems, different pictures frequently include the identical points. For example, the information on a temperature of a certain air conditioner is displayed on a plurality of pictures. Accordingly, this embodiment is specifically effective on the monitoring system.

For example, a picture 101 and a picture 301 include common points referred to as point 10, respectively. Reading processing is executing for the picture 101. In this situation, when the Web server 70 collects the points regarding the picture 301, only the values of the remaining point ID with 20 and the remaining point ID with 30 are enough to be obtained, since the values of the points having the point IDs of 10 have already been under reading.

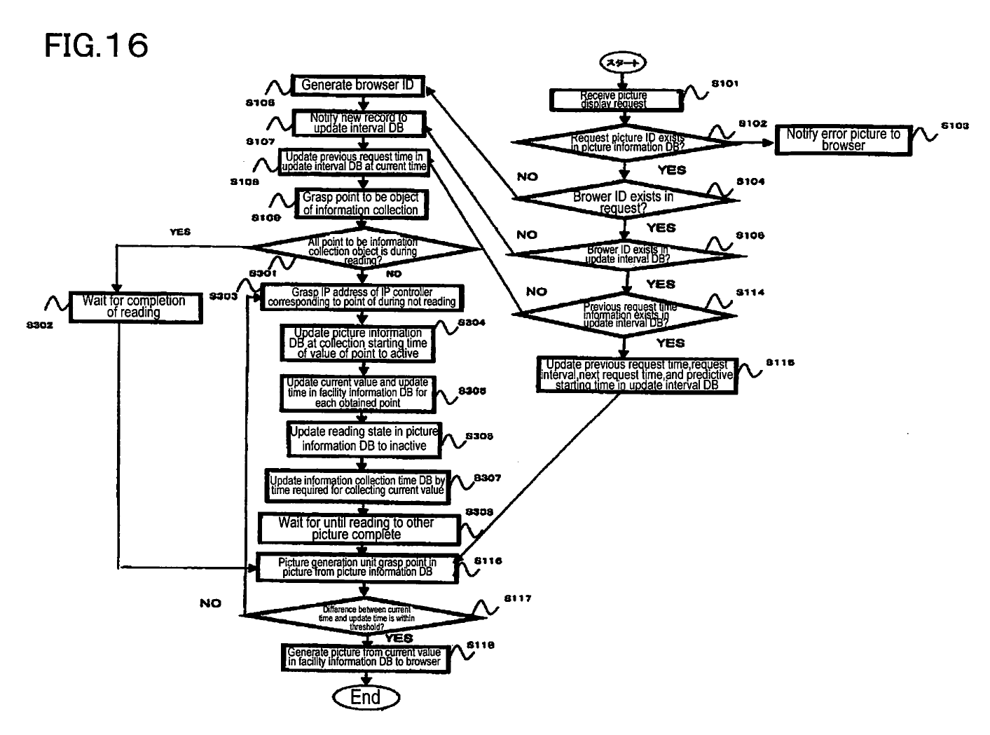

Next, operations in reception of the picture requests of the Web server 700 will be explained referring to FIG. 2 and FIG. 16. FIG. 16 is a flowchart showing the operations of the Web server 700. In the flowchart, the same numbers are attached to the steps which operate the same operations as those of the Web server in the embodiment 1.

Hereinafter, the steps which operate different operations will be mainly explained. Web server 700 is different form the Web server 200 of the example 1 in the process for collecting the points.

Hereinafter, a case in which the points are sequentially collected when receiving requests, such as a first picture display request from the Web browser 100, will be explained.

In S108, the collection control unit 21 of the information collection unit 20 updates the previous request time in the update interval DB 50 at the current time. The collection control unit 21 referrers to the picture information DB 40 and obtains the point ID groups included in the requested picture as the information collection point ID groups (S109). The collection control unit 21 confirms whether or not all the points of the information collection points ID are in currently reading execution (301). That is, at first, the collection control unit 21 refers to picture information DB 40 to confirm whether there exists any picture, the reading processing state of which is in “executing”.

If any picture has been in “executing”, the point ID groups included in all the “executing” pictures are compared with point ID groups which is the information collection object. If all the point ID groups which are objects of the information collection are included in the point ID groups included in the pictures in “executing”, the operation proceeds to S302. That is, the collection control unit 21 waits for completion of collection of all the point values of the point ID groups included in the picture during execution (S302). When the values of all the points are collected, the picture generation unit 30 generates the picture information to notify it to the Web browser 100 (from S116 to S118).

On the other hand, the operation proceeds to S303 in a case in which there is no picture in “executing”, and in a case in which there is any picture in “executing” but all the point ID groups of information collection are not included in the point ID groups included in the pictures in “executing”.

After the step S303, the collection control unit 21 performs point reading processing which is not in reading process among the information collection point ID groups. The collection control unit 21 does not perform reading of the points which are in reading processing, and waits for the completion of the reading by other pictures (S308). On the other hand, if there is no point in reading processing, the collection control unit 21 collects all the points included in the pictures requested.

At first, the collection control unit 21 refers to the facility information DB 70, and obtains the IP addresses of the IP controllers 300 of the point which are not in the reading process among information collection point ID groups (S303). The collection control unit 21 starts the collection of the values of the points to update the reading processing state of the picture information DB 80 to “executing” (S304). The collection control unit 21, after collection of the values of the point values which are not in the reading process, updates the current values and the update times of the facility information DB 70 (S305).

Next, the collection control unit 21 updates the reading processing state of the picture information DB 80 to “not executing” (S306). The collection control unit 21 reflects the time required to collect the values of the points to the information collection time DB 60, as collection times (S307). Then, as described above, the collection control unit 21 of the information collection unit 20 waits for the completion of the reading of the points in the reading process for the other picture requests among information collection point ID groups (S308). Then, the collection control unit 21 directs the picture generation unit 30 to start the picture generation. The picture generation unit 30 generates the picture information to notify it to the Web browser 100 (from S116 to S118).

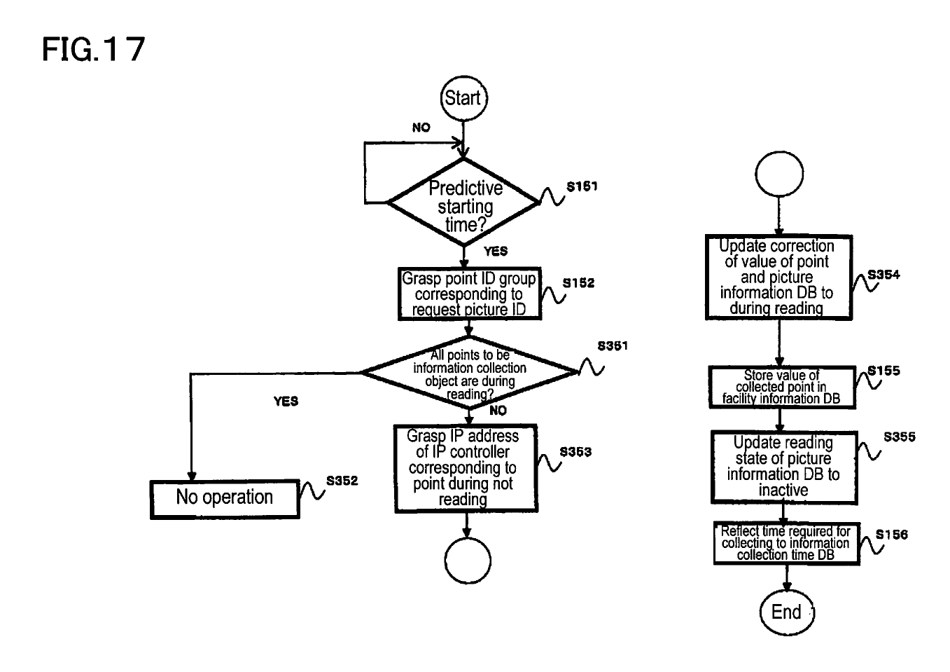

Next, the pre-reading processing of the Web server 700 according to the embodiment 3 will be set forth by referring to FIG. 2 and FIG. 17. FIG. 17 is a flowchart depicting operations of the Web server 700 of the embodiment 3. The identical numbers are attached to the steps of the same operations as those of the flowchart of FIG. 9. Hereinafter, the points different from the flowchart of FIG. 9 will be mainly set forth.

At first, when the time designated in the pre-reading starting time of each record of the update interval DB 50 comes (S151), the collection control unit 21 refers to the picture information DB 40 to obtain, as information collection object points, the point ID groups included in the request object picture IDs included in the picture request (S152)

Next, referring to the picture information DB 40, the collection control unit 21 confirms whether or not all the points included in the information collection object point ID groups are in the reading execution (S351). In other words, at first, the collection control unit 21 refers to the picture information DB 4, and confirms whether there are the pictures in which the reading processing states is in “executing”. If there are pictures which are in “executing”, the point ID groups included in all the “executing” pictures are compared with the information collection object point ID groups. If all the information collection object point ID groups are included in the point ID groups included in the pictures “executing”, the operation proceeds to S352. That is, the collection control unit 21 does not perform any operation (S352).

On the other hand, if there is no “executing” picture and in a case in which there is the picture in “executing” but all the information collection point ID groups are not included in the point ID groups included in the picture of “executing”, the operation proceeds to S353.

In the steps following the step S353, the collection control unit 21 performs the reading process of the points which have been not in reading process among the information collection point ID groups, and does not perform the reading of the points which are in reading process. On the other hand, if there are no points in reading process, the collection control unit 21 collects the values of all the points included in the request object picture. Firstly, the collection control unit 21 refers to the facility information DB 70 to obtain the IP addresses of the IP controllers 300 of the points which are not in the reading process among the information collection point ID groups (S353).

Next, the collection control unit 21 starts the collection of the values of the points to update the reading processing state of the picture information DB 80 to “executing” (S354). After collection of the values of the points which are not in the reading process, the collection control unit 21 updates the reading processing state of the picture information DB 80 to “not executing” (S355). The collection control unit 21 reflects the time required for the collection of the values of the points to the information collection time DB 60, as the collection time (S156).

As is described above, the processing load on the IP controller of the Web server 200 can be reduced in comparison with the embodiment 2, since the overlapping of the reading processing is determines based on the point in the embodiment 3. The traffic on the facility network can be also reduced.

As mentioned above, the Web server 700 compares the point IDs which are the objects of the information collection with the point IDs in the reading process, and does not perform the reading processing with respect to the overlapped point IDs. As a result, the reading processing with respect to the identical points IDs in a short time can be prevented from being performed, and the load on the IP controller can be reduced.

According to the Web server 700, in a way similar to the embodiment 1, the speed to transmit the picture information for the picture request from the Web server can be improved, since the pre-reading processing can be performed.

### Embodiment 4

Next, a Web server 800 according to an embodiment 4 will be explained. FIG. 1 illustrates a constitution of a building management system including the Web server 800 of the embodiment 4. FIG. 2 illustrates a constitution of the Web server 800. Here, the picture information DB of the Web server 800 is the picture information DB 40.

The Web server 800 of the embodiment 4 performs reading processing to an IP controller 300, however, it prevents from performing the reading processing of the points again just after the time at which the values (current values) have been updated for the facility information DB. That is, in the web server of the embodiment 2 and embodiment 3, the load on the IP controller 300 is reduced by avoiding the overlapped reading processing to the identical IP controller 300. However, the Web server 800 intends to reduce the load on the IP controller 300 by preventing from performing the reading processing to the identical IP controller again just after the time at which the values of the points from the IP controller 300.

The information collection unit 20 of the Web server 800 according to the embodiment 4 compares the calculated values by subtracting the update time included in the facility information DB from the current time (the time when receiving the picture request, or pre-reading starting time) for each point ID with respect to the picture request (or, pre-reading which is performed at the pre-reading starting time) with the shortest update interval which is a predetermined value and is stored in the information collection unit 20. Then, if the calculated value is larger than the shortest update interval, the information collection unit 20 collets the values of the points corresponding to the point IDs. On the other hand, if the calculated value is not larger than the shortest update interval, the values of the points corresponding to the point IDs are not collected. That is, if the shortest update interval has not elapsed from the time at which the values of the previous point IDs have been collected, the reading process is not performed. Thereby, the load of the IP controller 300 can be reduced.

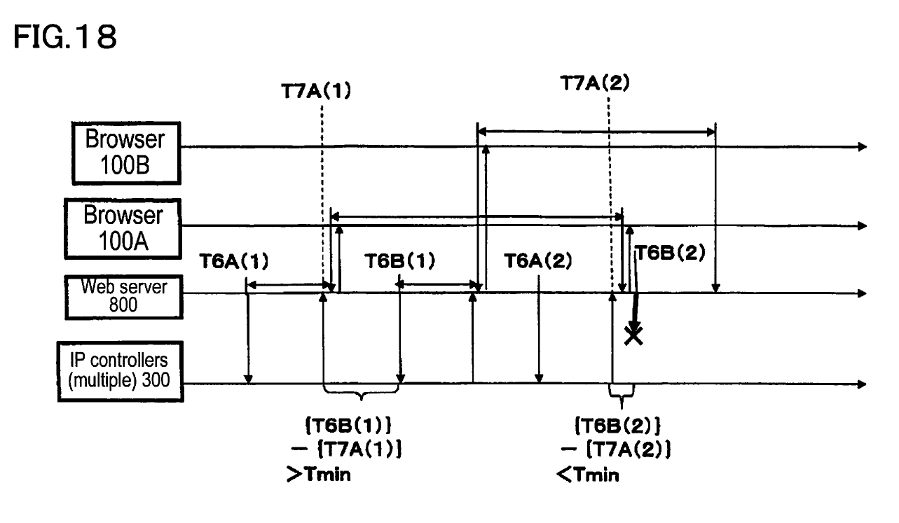

FIG. 18 shows a time chart of the Web server 800. Hereinafter, when the pre-reading starting time comes, examples of cases in which the Web server 800 performs the pre-reading, and of cases in which the Web server 811 does not perform the pre-reading will be set forth by practical examples. In FIG. 18, it is assumed that a Web browser 100A and a Web browser 100B issue picture display requests to the identical picture. It is also assumed, as shown in FIG. 18 for example, that pre-reading starting times for the picture information generation to the Web browser 100B are set to T6B(1), T6B(2), that pre-reading starting times for the picture information generation to the Web browser 100A are set to T6A(1), T6B(1), that the collection of the values of the points for the picture information generation to the Web browser 100A has been completed, and that the times at which the setting information DB are set to T7A(1), T7A(2). At this moment, the pre-reading starting time T6B (1)−the update time T7A(1) exceeds the shortest update interval Time. Accordingly, the Web server 800 starts the pre-reading for the picture generation of the Web browser 100B at the pre-reading starting time T6B(1). On the other hand, the pre-reading starting time T6B(2)−The update time T7A(2) is less than the shortest update time T min. Accordingly, in this case, the Web server 800 does not perform the pre-reading for the picture generation of the Web browser 100B at the pre-reading starting time T6B. Here, in this practical embodiment, although the browsers 100A and the 100B request the identical pictures, the embodiment is not limited to the above embodiment. In a case where the Web browser 100A and 100B each request different pictures, if there exists overlapped points among the different pictures, and if the difference between the pre-reading starting time for the picture generation of the Web browser 100B and the update time for the picture generation of the Web browser 100A is less than the shortest update interval T min, the Web server does not collect the values of the overlapped points for the picture generation of the Web browser 100B, and may collect the values of the overlapped points.

Next, the operations of the Web server 800 will be set forth. The Web server 800 is different from the Web server 200 of the example 1 in the operation in the S110 where the operation in receiving the picture display request is performed and in the operation in the S153 where the operation in the pre-reading processing is performed. Since the different points in the operations in the S110, S153 are the same with each other, hereinafter, the different portion from the operation in the S110 will be explained.

When collecting the values of the points included in the picture display requests, the collection control unit 21 refers to the picture information DB to obtain the point ID groups which are the objects of the collection in the S109, and refers to the facility information DB 70 to obtain the IP controller 300 which manages each point of the point ID groups which are the objects of the collection in the S110. The Web server 800 refers to the update times of the collection object point IDs, in the S100, when further referring to the facility information DB 70. Then, the Web server 800 collects the values (current values) of the points following the S111 with respect to the points which satisfy the following formula (4), and the Web server 811 does not perform the processing after the S111 and does not collect the values (current values) of the points with respect to the points which do not satisfy the formula (4).

The current time−the previous update time>the shortest update time (T min) (4)

The processing following the S111 is similar to the processing of the Web server of the embodiment 1.

As described above, the intervals of the reading processing to the IP controller 300 can be set longer than the shortest update intervals by setting the shortest update interval. Thus, the reading processing with respect to the identical points IDs in a short while and the load on the IP controller can be decreased.

According to the Web server 700, in the same way as the embodiment 1, the speed for transmitting the picture information from the Web server to the picture display requests can be increased due to the pre-reading processing.

### Embodiment 5

Next, a Web server 900 according to an embodiment 5 will be explained. FIG. 1 shows a configuration of a building management system including the Web server 900 of the embodiment 5. FIG. 2 shows the configuration of the Web server 900. Here, the information collection DB of the Web server 900 is an information collection DB 90, and differs from the information collection DB. The picture information DB is the picture information DB 40.

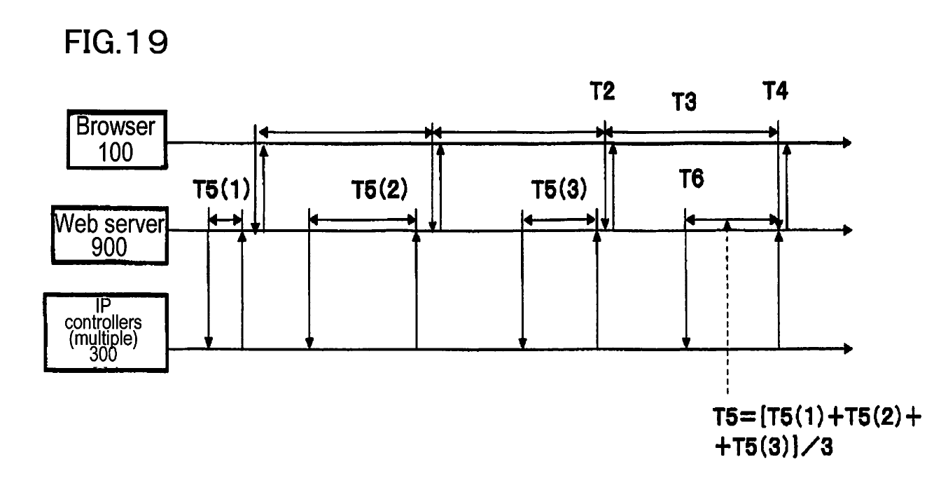

FIG. 19 shows a time chart of the Web server 900. In some times, an IP controller with low performance has a deviation of the times from the time of the reception of the information collection requests to the time of returning of them. As shown in FIG. 19, in such a case, the collection times in which the Web server collects the values of the points from the IP controller 300 vary. As mentioned above, the pre-reading starting time T6 is calculated by subtracting the collection time T5 from the next request time T4. In the embodiment 1, the collection time at which the value of the previous time has been collected is used as the collection time. To calculate the pre-reading starting time T6 more accurately, the Web server 900 of this embodiment stores the collection times of the previous several times, and uses averaged values, maximum values, minimum values, etc., as the collection times to be used for the calculation of the pre-reading starting time T4. Thus, the transmission of the picture information to the Web browser 100 can be executed at a faster speed without having variations, since it is possible to calculate pre-reading times more accurately without having variations. For example, in FIG. 19, the averaged value of the previous three times T5(1), T5(2), T5(3) is calculated as to the collection time T5 for calculating the pre-reading starting time.

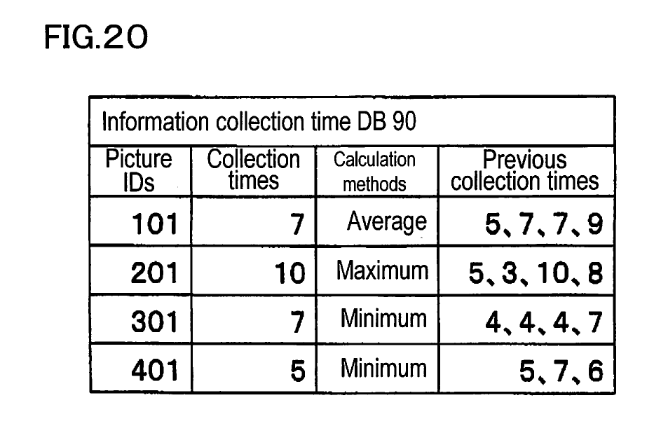

FIG. 20 illustrates an example of the information collection time DB 60 of the embodiment 5. The information collection time DB manages a collection time, a calculation method, and a previous collection time for each picture and for each picture ID. The previous collection time stores the time required for the collection of the values of the points for the picture ID at every completion of the collection of the values of the points for the picture ID by the information collection unit 20. The times to be recorded for the previous collection times are predetermined. The collection time is the result in application of the calculation method designated by the calculation method to the previous collection times. For example, in the picture ID 101, the previous collection times are 5, 7, 7, 9 and thus 7 is stored as the previous collection times since the calculation method is averaging of the previous collection times.

As described above, the Web server 900 of the embodiment 5 calculates the collection times to calculate the pre-reading time using the previous several times of previous collection times, and can calculate pre-reading times more accurately without variations, so that it can transmit the picture information to the Web browser 100 at a faster speed without variations.

Since the Web server 700 can perform the pre-reading processing in the same way as that of the embodiment 1, and thus can increase the speed to transmit the picture information in response to the picture display request from the Web server.

Here, the Web server 200 can be realized by using, for example, a general computer as a basic hardware. That is, the request reception unit 10, the information collection unit 20, the picture generation unit 30, the picture information DB 40, the update interval DB 50, the information collection time DB 60 and the facility information DB 70 can be realized by executing a program on a processor mounted on the computer device. In this case, the Web server may be realized as a computer device with the program installed into the computer device previously, with the program stored into the storage medium, such as a CD-ROM, or with the program delivered via a network and is appropriately installed into the computer device. Further, the picture information DB 40, the update interval DB 50, the information collection time DB 60, and the facility information DB 70 can be realized by appropriately utilizing a storage device, such as a memory incorporated into or externally attached to the computer device, a hard disc, a CD-R, a CD-RW, a DVD-RAM, a DVD-R and the like. Web servers 600, 700, 800, 900 are also realized in the similar way.

Although examples in which the Web servers are applied to the building management systems have been set forth from the embodiment 1 to the embodiment 5, the invention is not limited to those examples. Specifically, the Web server can be applied to a management system for facility equipment.

Here, the invention is not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments, Some of the elements, for example, may be omitted from the whole of the constituent elements shown in the embodiment mentioned above. Further, the constituent elements over different embodiments may be appropriately combined.

What is claimed is:

1. An information presentation device, comprising:
a request reception unit which receives a picture request which includes an picture identification (ID) which specifies a request picture from an external program;
a facility information database (DB) which stores a point ID which is information of external equipment connected to a management device and a value of the point;
a picture information DB which stores the point ID which is stored in the facility information DB and a picture ID which specifies a picture which displays the value of the point specified by the point ID corresponding to each other;
a collection time DB which stores a collection time which is required to collect the value of the point corresponded to the picture ID;
an information collection unit which calculates a request interval when receiving the picture request signal from the request reception unit, a request interval by subtracting a previous request reception time from the request reception time which is a time at which the picture request has been received, which calculates the next request reception time by adding the request interval to the request reception time, which calculates a pre-reading starting time by subtracting the collection time from the next request reception time, and which directs the management device to start the collection of the value of the point when the pre-reading starting time comes; and
a picture generation unit which obtains the value of the point from the facility information DB and generates the picture to transmit the picture from the values of the obtained point when receiving the picture request from the request reception unit.

2. The information presentation device according to claim 1, wherein the picture information DB stores a reading processing state which indicates that the information collection unit is in a process of obtaining the points while it is obtaining the value of the point to be specified by the point ID corresponding to the picture ID, and does not obtain the value of the point to be specified by the point ID of the picture ID, even when the pre-reading starting time comes or even when the picture processing request signal received, if the information collection unit is in the reading processing state with respect to the picture ID which becomes the pre-reading processing starting time or with respect to the same picture ID as the picture ID included in the picture request.

3. The information presentation device according to claim 2, wherein the information collection unit does not obtain the value of the point from the management device, when the pre-reading starting time comes, or even when receives the picture request, if the picture ID which has arrived at the pre-reading processing starting time, or the point ID corresponding to the picture ID included in the picture request coincides with the point ID corresponding to the picture ID being in the reading state of the picture information DB.

4. The information presentation device according to claim 3, wherein the facility information DB stores the update time in which the value of the point to be specified by point ID by corresponding to the point ID, and wherein
the information collection unit does not obtain the value of the point from the management device, when the pre-reading starting time comes, or even when receiving the picture request, if the difference between the time at which the pre-reading starts or the picture request receives and the update time is shorter than a predetermined time.

5. The information presentation device according to claim 4, wherein the collection time DB stores a collection time for collecting the value of the point which displays the values on the picture specified by the picture ID by multiple times, and calculates the collection time for pre-reading starting time calculation from these collection times.

6. A computer-readable non-transitory storage medium storing a program for causing a computer to execute an information presentation device, comprising:
receiving a picture request which includes an picture identification (ID) which specifies a request picture from an external program with a request reception unit;
storing a point ID which is information of external equipment connected to a management device and a value of the point in a facility information database (DB);
storing the point ID which is stored in the facility information DB and a picture ID which specifies a picture which displays the value of the point specified by the point ID corresponding to each other in a picture information DB;
storing a collection time which is required to collect the value of the point corresponded to the picture ID in a collection time DB;
calculating a request interval, when receiving the picture request signal from the request reception unit, by subtracting a previous request reception time from the request reception time which is a time at which the picture request has been received, calculating the next request reception time by adding the request interval to the request reception time, calculating a pre-reading starting time by subtracting the collection time from the next request reception time, and directing the management device to start the collection of the value of the point when the pre-reading starting time comes; and
obtaining the value of the point from the facility information DB and generates the picture to transmit the picture from the values of the obtained point when receiving the picture request from the request reception unit.
